(19) United States
(12) Patent Application Publication
(10) Pub. No.: US 2013/0282767 A1
(43) Pub. Date: Oct. 24, 2013

(54) COMPUTING DEVICE, SYSTEM, METHOD AND DATA SIGNAL ARRANGED TO FACILITATE INFORMATION SHARING

(71) Applicant: ICONSTRUCT (AUS) PTY LTD, Applecross (AU)

(72) Inventor: Shawn WEIR, Applecross (AU)

(73) Assignee: ICONSTRUCT (AUS) PTY LTD, Applecross (AU)

(21) Appl. No.: 13/865,293

(22) Filed: Apr. 18, 2013

(30) Foreign Application Priority Data
Apr. 18, 2012 (AU) 2012901531

(51) Int. Cl. G06F 17/30

(52) U.S. Cl. CPC G06F 17/30289
USPC 707/803

(57) ABSTRACT

In one aspect, the present invention provides a computing device comprising a processing module arranged to interact with a centralized database via a communications network. The invention further includes a database arranged to contain information regarding one or more components within a complex model. The module is arranged to provide the information via the communications network from the device to the centralized database.

### TECHNICAL FIELD

The present invention relates to a computing device, system, method and data signal arranged to facilitate information sharing. Embodiments of the invention find particular, but not exclusive, use in the field of documenting and modeling complex systems, such as engineering projects, architecture and building projects, and manufacturing processes.

### BACKGROUND ART

With the advent of software capable of documenting, modeling and rendering complex systems, there has been a growth in the need for such software to be used contemporaneously by a large number of professionals or experts. In the context of the present specification, the term ‘complex system’ is used to denote any type of technical or quasi-technical system that comprises a large number of components, parts and connections or links.

Examples of complex systems may include (without limitation) large manufacturing facilities, mining operations, oil and gas refineries, large construction projects, utilities modeling (e.g. electricity, water and sewerage networks and systems), or even non-technical complex systems such as organizational structures, and economic and social structures.

One product, marketed under the name “Navisworks”, allows users to create complex engineering and architectural models, visualize the models in three dimensions and document features of the models, so that other users may better understand the models. The product facilitates collaborative interaction by allowing a large number of users to work on a model in an efficient and productive manner.

When a product such as Navisworks is used for large engineering projects, it is quite common for a large number of users to contribute to and refine the model. As such, there is a need to track changes to the model, and there is also a need to allow the user to provide comments, so that subsequent users may better understand the context in which a model was updated or modified.

### SUMMARY OF INVENTION

In a first aspect, there is provided a computing device comprising a processing module arranged to interact with a centralized database via a communications network and a database arranged to contain information regarding one or more components within a complex model, wherein the module is arranged to provide the information via the communications network from the device to the centralized database.

In one embodiment, the device generates a unique identifier for each item of information regarding at least one of the one or more components within the complex model.

The unique identifier may be provided with the information to the centralized database.

In addition, the unique identifier may be stored locally as a part of the model.

The centralized database may be updated via the communications network on a periodic basis.

In a second aspect, the present invention provides a system arranged to interact with one or more remote devices via a communications network comprising a server including a database arranged to contain information regarding one or more components within a complex model, wherein the database is arranged to receive the information via the communications network from the one or more remote devices.

In one embodiment, the system is further arranged to, on receipt of a request from the one or more remote devices, provide the information regarding one or more components within the complex model to the one or more remote devices.

In a third aspect, the present invention provides a method for facilitating the transfer of information regarding one or more components within a complex model between one or more remote devices and a centralized database, comprising the steps of, the centralized database receiving a request to provide the information regarding one or more components within the complex model to the one or more remote devices, and forwarding the information via a communications network to the one or more remote devices.

In a fourth aspect, there is provided a computer program, including at least one instruction capable of being executed by a computing system, which implements a method in the third aspect of the invention.

In a fifth aspect, there is provided a computer readable medium including a computer program in accordance with the fourth aspect of the invention.

In a sixth aspect, there is provided a data signal including at least one instruction being capable of being received and interpreted by a computing system, wherein the one instruction, on being interpreted by the computing system, implements a method in accordance with the third aspect of the invention.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is an example computing system which is capable of operating a device, system, method and/or computer program in accordance with an embodiment of the present invention; and

FIGS. 2 to 8 are screenshots illustrating input screens utilised by a user when interacting with an embodiment of the present invention.

### DESCRIPTION OF EMBODIMENTS

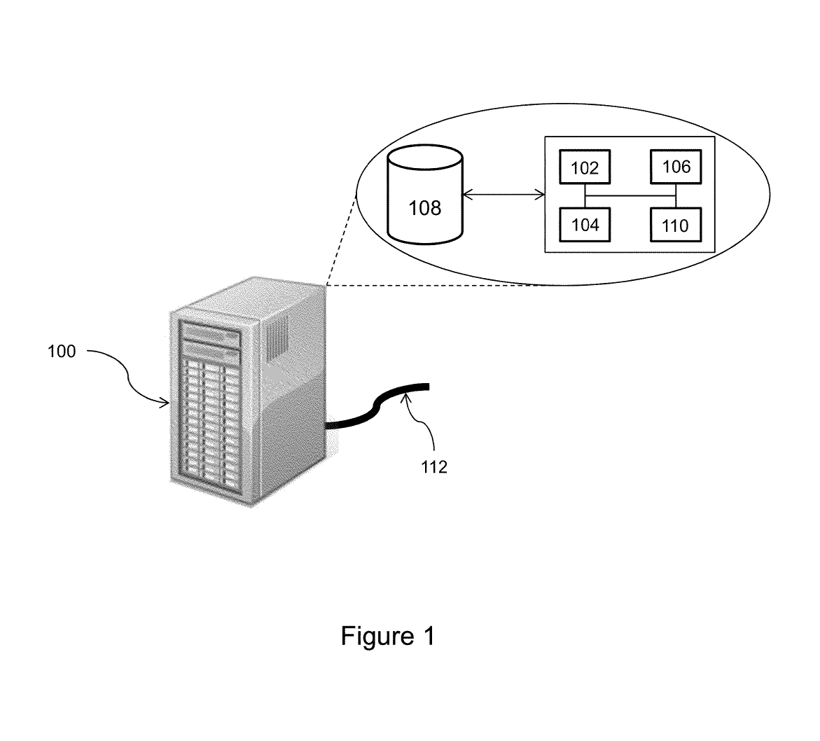

Referring to FIG. 1, there is shown an example computing system which is capable of facilitating transactions in accordance with an embodiment of the present invention.

In FIG. 1 there is shown a schematic diagram of a computing system, which in this embodiment is a server 100 suitable for use with an embodiment of the present invention. The server 100 may be used to execute application and/or system services such as a system and method for facilitating an electronic financial transaction in accordance with an embodiment of the present invention.

With reference to FIG. 1, the server 100 may comprise suitable components necessary to receive, store and execute appropriate computer instructions. The components may include a processor 102, read only memory (ROM) 104, random access memory (RAM) 106, an input/output devices such as disc drives 108, input devices 110 (such as an Ethernet port, a USB port, etc.), display (not shown) such as a liquid crystal display, a light emitting display or any other suitable display and one or more communications link(s) 112.

The server 100 includes instructions that may be installed in ROM 104, RAM 106 or disc drives 108 and may be executed by the processor 102. There may be provided a plurality of communication links 112 which may variously connect to one or more computing devices such as servers, personal computers, terminals, wireless or handheld computing devices, or mobile communication devices such as a mobile (cell) telephone. At least one of a plurality of communications links may be connected to an external computing network through a telecommunications network.

In one particular embodiment the device may include a database which may reside on the storage device 108. It will be understood that the database may reside on any suitable storage device, which may encompass solid state drives, hard disc drives, optical drives or magnetic tape drives. The database may reside on a single physical storage device or may be spread across multiple storage devices.

The server 100 includes a suitable operating system which may also reside on a storage device or in the ROM of the server 100. The operating system is arranged to interact with the database and with one or more computer programs to cause the server to carry out the steps, functions and/or procedures in accordance with the embodiments of the invention described herein.

The database is arranged to contain a series of Global Unique Identifiers (GUID) which reference a particular “viewpoint” within a complex model. In more detail, in some software modeling and documenting packages, there is provided a further module or routine which allows the user to render a two-dimensional or three-dimensional model of the complex system. Such models are more intuitively understandable to a human user, as humans generally have much better spatial visualization capabilities and are able to comprehend a visual model more easily than written information.

Generally, the module or routine accesses the stored information in a systematic format, such that each component (or sub-set of components) that form the model is separately held as a discrete set of data. Such discrete sets of data are in effect a ‘set of instructions’ that is used by the module or routine within the software package to construct the two dimensional or three dimensional visual ‘model’. In the context of the present specification, the term “viewpoint” is utilized to denote such a discrete set of data.

Other information that is not strictly necessary for the rendering of a two dimensional or three dimensional image may also be associated with the viewpoint. For example, a user may wish to add explanatory or clarifying notes which may be useful to another user of the system. Such notes may include reference to manufacturing, assembly, construction or material specifications, reference to any known issues with the design as rendered, completion times and dates, etc., or any other information that may be useful to the user. Such information is also saved in the database and is generally displayed in any suitable manner (such as in a ‘text box’ below or beside the rendered image).

When complex systems are modeled, it is generally necessary to receive input from a number of professionals, who may be located at a number of remote locations. For example, a complex engineering project, such as the planning and building of an oil refinery, a mining operation, a manufacturing plant, or a high rise building (to name a few examples) may require input from a number of different parties, including engineers, architects, surveyors and other specialists. Each party may work on the complex system independently of and/or contemporaneously with other parties. As such, a number of different ‘versions’ of the complex system may be developed, each with slightly different specifications, emphases, modifications and comments. The development of a large number of subtly different models becomes a logistical nightmare to manage, and increases the risk of errors being made and information not being clearly communicated between parties. This is particularly the case where each party is using a stand-alone version of the modeling software.

To ameliorate this problem, the embodiment described herein provides a product which is marketed under the name “ReviewTrack™”, which is provided as a plug-in module to an existing product marketed under the name “iConstruct™” ReviewTrack provides a system and centralized database which holds all models and comments within a centralized database. The models can be remotely accessed by one or more instances of the iConstruct software.

iConstruct is capable of modeling complex systems by creating a database that is capable of holding information regarding a large number of “objects” and their inter-connections. iConstruct further provides a visualization facility that allows a user to create “Viewpoints”. Viewpoints are a visual “snapshot” of a number of objects and their interconnections.

For example, if iConstruct is being used to model a public utility, such as an electricity grid, the “model” would be the electricity grid as a whole. The “objects” would include all components that make up the grid, from power stations to transformers, junction boxes and power lines. A Viewpoint would be akin to “zooming in” on a portion of the network (such as a sub-station) to visualize the portion of the network. A comment is information (usually textual information) that is associated with either an object or a Viewpoint that can be used to provide further contextual or explanatory information to the user. It is generally displayed when a user accesses a viewpoint (as shown in the Figures, which are described in more detail later).

In order to be able to share information easily between different users, ReviewTrack utilises a 128 bit Globally Unique Identifier (GUID) which is associated with each object in a model.

Each GUID associated with an object is created (i.e. generated) by the ReviewTrack module upon the creation of a new Viewpoint or the adding of a new comment to an existing Viewpoint.

In the example embodiment described herein, the GUID is generated using Microsoft's .NET™ standard (an application development framework available from Microsoft Corporation). In particular, the GUID is generated by calling the GUID class in the .NET standard.

Once the GUID is generated, it is stored in the model as the comment body as text and contemporaneously it is also stored in the centralized database as a GUID field in a record of data containing the original body of the comment.

For each viewpoint the text format of the GUID is:
“{VPID}XXXXXXXX-XXXX-XXXX-XXXX-XXXXXXXXXXXX”
   where each ‘X’ represents one digit of a 32-character hexadecimal string.

Similarly, the GUID associated with each comment the text format is:
“{CMID}XXXXXXXX-XXXX-XXXX-XXXX-XXXXXXXXXXXX”
   where each ‘X’ represents one digit of a 32-character hexadecimal string.

In more detail, the GUID generation algorithm relies on the fact that it has all 16 bytes to use to establish uniqueness. The value of a GUID is represented as a 32-character hexadecimal string, such as:
{21EC2020-3AEA-1069-A2DD-08002B30309D},
   and is stored as a 128-bit integer. The total number of unique keys is 2¹²⁸ or 3.4×10³⁸. This number is so large that the probability of the same number being generated randomly twice is negligible.

The first 60 bits of the GUID encode a timestamp. The next four bits are always 0001, which identify that this GUID was generated by “algorithm 1”. The version field is necessary to ensure that two GUID generation algorithms do not accidentally generate the same GUID. The algorithms are designed so that a particular algorithm doesn't generate the same GUID twice. However, without a version field, there would be no way to ensure that another algorithm doesn't generate the same GUID by some systematic collision.

The next 14 bits are “emergency uniquifier bits”; which are used for fine-tuning of the algorithm. The next two bits are reserved and fixed at 01. The last 48 bits are the unique address of the computer's network card. If the computer does not have a network card, then the top bit is set and random number generator is used to generate the other 47 bits. No valid network card has the top bit set in its address, so there is no possibility that a GUID generated from a computer without a network card will accidentally collide with a GUID generated from a computer with a network card.

The bits of the GUID is arranged in the following manner:

60 bits—timestamp;

48 bits—computer identifier;

14 bits—uniquifier; and

6 bits—fixed,

for a total of 128 bits.

In other words, the algorithm uses the combination of time and location (“space-time coordinates”) as the uniqueness key. However, timekeeping is not perfect, so there is a possibility that, for example, two GUIDs are generated in rapid succession from the same machine, so close to each other in time that the timestamp would be the same. Therefore, the uniquifier adds another element to further distinguish the GUID.

If two requests for a GUID are made in rapid succession or if the system clock is set to a new time, the uniquifier is incremented so that there can be no overlap in the GUIDs generated.

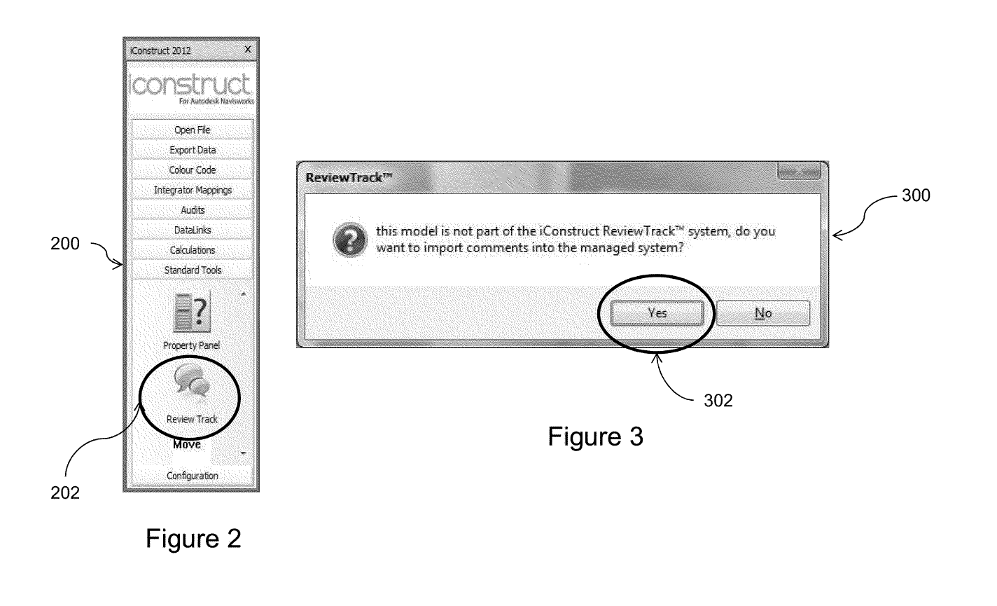

With reference to FIG. 2, there is shown a start-up ‘screen’ for iConstruct, which includes an icon 202 which accesses the ReviewTrack module.

With reference to FIG. 3, the ReviewTrack module interacts with a model held within the iConstruct database by firstly asking users whether they wish to import the model into the manager, as shown at dialogue box 300. By pressing ‘Yes’ (icon 302), the system generates a GUID (a Global Unique Identifier) for each ViewPoint with the following syntax:
{VPID}xxxxxxxx-xxxx-xxxx-xxxx-xxxxxxxxxxxx
   where xxxxxxxx-xxxx-xxxx-xxxx-xxxxxxxxxxxx is a unique alphanumeric identifier.

The ViewPoint definition is then stored in a centralized database with reference to the created GUID. Each of the existing user comments which reside on the local database and associated with the Viewpoint are then imported to the centralized database and the body of the comment in the local database is replaced with a string with the following syntax:
{CMID}xxxxxxxx-xxxx-xxxx-xxxx-xxxxxxxxxxxx
   where xxxxxxxx-xxxx-xxxx-xxxx-xxxxxxxxxxxx is the unique alphanumeric identifier that matches the “VPID” identifier in the centralized database. In this way, a link is created between the comments that are stored on the local database associated with the iConstruct application, and with a centralized database that is accessible by all users who interact with the same model.

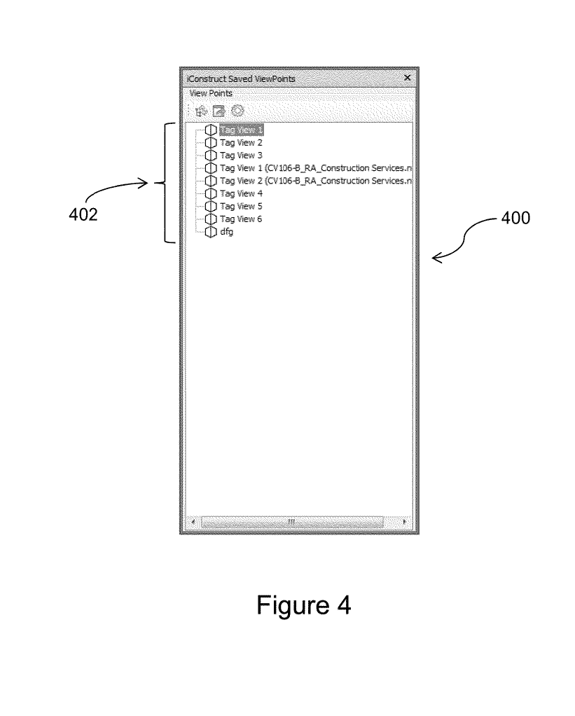

The module may be accessed by a user in one of two ways. The first, as shown with reference to FIG. 4, is via the ‘Construct Saved ViewPoints’ panel 400. This panel provides a ‘tree’ view (generally denoted at 402) into the comments related to one or more Viewpoints. Moreover, this panel directly controls the Viewpoints as saved in the centralized database. Users can add new ‘Saved Viewpoints’, edit a comment name, create ‘Folder Views’, and drag-drop viewpoints into the folder views. Each of the above actions causes both the model and the centralized database of the managed system to be updated.

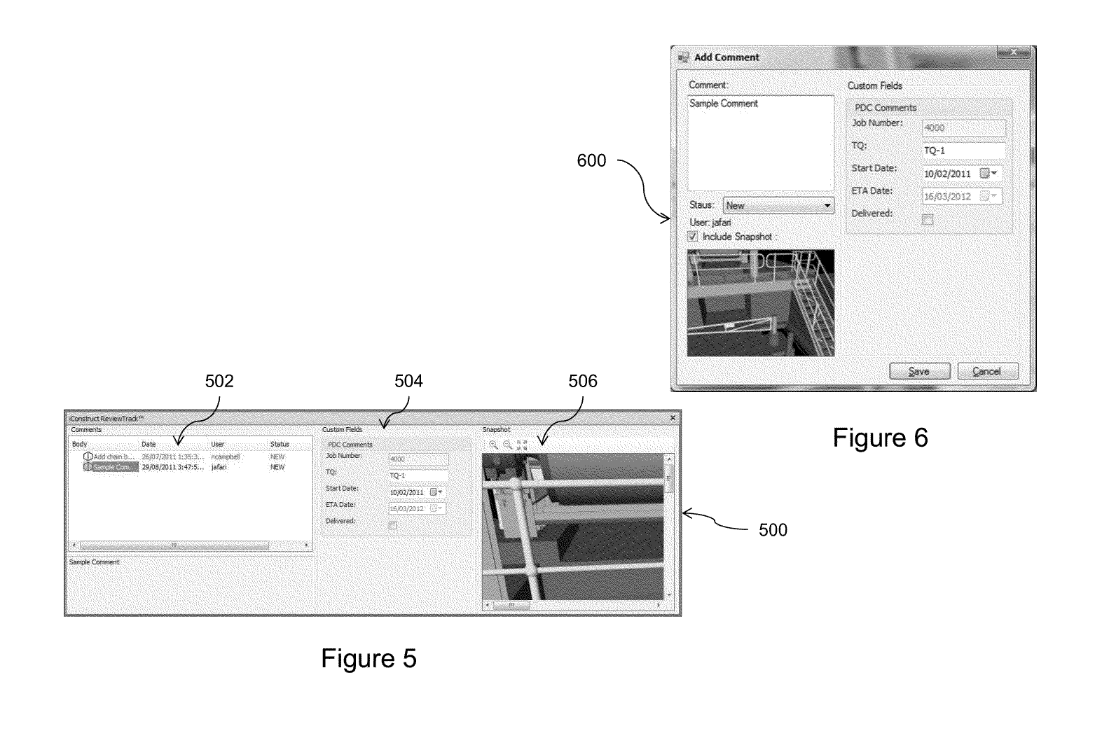

The second panel 500, an example of which is shown at FIG. 5, “iConstruct ReviewTrack™” comments list, shows each comment of the selected viewpoint by retrieving the comment from the centralized database based on the GUID stored in the model. This panel has 3 sections: Comments (502), Custom Fields (504), and Snapshot (506). In the comments section 502 all user comments plus the issue-date, username, and status of the comment are displayed as a list. By selecting each comment, the body of the selected comment is displayed separately at the bottom of the list.

In the custom fields section 504 each user can customize their own data source storage for storing any data related to the model, viewpoint or each comment. It is also possible to have more than one custom data sources if there is a need to store data in multiple formats.

In the snapshot view of the selected viewpoint section 506, the user can scroll, zoom-in, zoom-out, and maximize the snapshot to a full-screen view. This image is available if at least one of the comments associated with the viewpoint is stored in the managed system with the ‘save snapshot’ check box activated.

Adding, editing or deleting each comment is also available from the “iConstruct ReviewTrack™” panel. By right-clicking on the list, a pop-up menu will be shown to the user with Add, Edit, Delete features.

Referring now to FIG. 6, there is shown an add comment window 600 will be shown to the user with four sections: Comment Body, Status, ‘include snapshot’ feature and Custom Fields section. The custom field section displays the exact fields shown in the “iConstruct ReviewTrack™” panel for each comment.

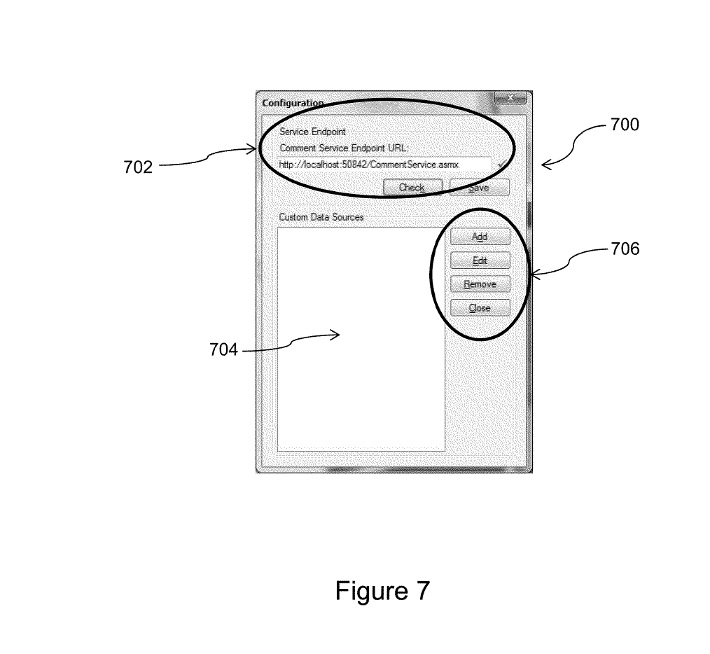

With reference to FIG. 7, the configuration panel of the Viewpoint module is accessible from the viewpoints toolbox. In the panel 700 a user can change the default Web Service Endpoint URL 702. The user can also choose which custom data sources are to be used as the secondary data source for storing comments and any customized information along with the comments (see data input box 704). In other words, the user can add, edit or delete any custom data source using the buttons on the right hand side of the form (generally denoted by 706).

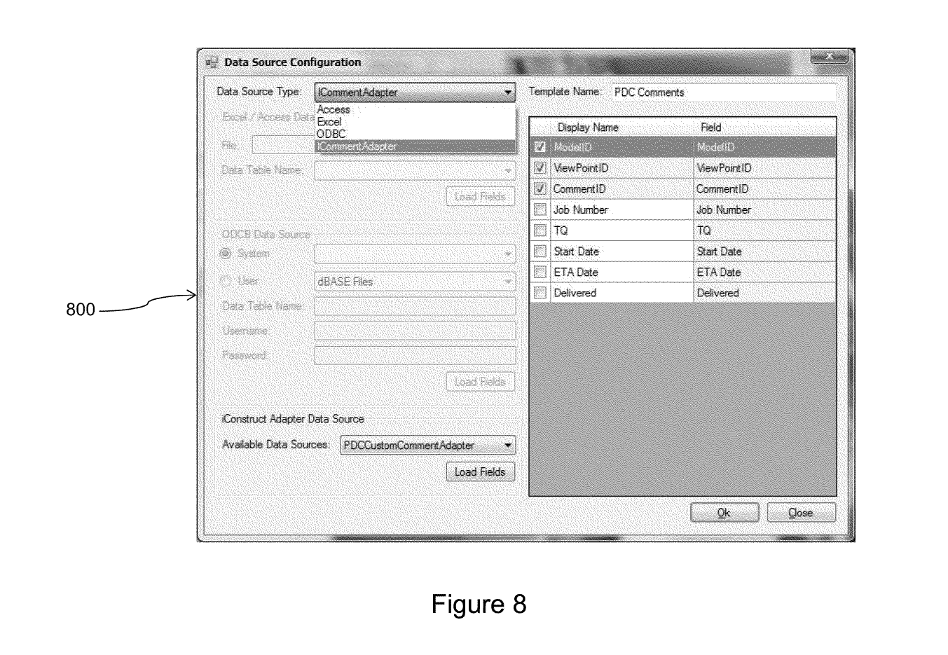

Referring to FIG. 8, there is also provided an external data binding option screen (generally denoted as 800) which allows users to configure any external data source to store customized information based on the needs of the customer. In the example embodiment described herein, four types of data sources are available, namely Access, Excel, ODBC, and iCommentAdapter (a proprietary data format).

Once a user selects one of the four types listed above, the user can select which fields are to be shown in the comment panel. The default display names of the fields can also be changed to make the display names more meaningful and relevant to the particular model or project.

### Variations and Modifications

Although not required, the embodiments described with reference to the figures can be implemented via an application programming interface (API) or as a series of libraries, for use by a developer, and can be included within another software application, such as a terminal or personal computer operating system or a portable computing device operating system, or within a transaction processing system. In one example, the Applicant provides an API dubbed ‘iCommentAdapter’, to allow developers to implement custom data sources for use within the ReviewTrack module.

Generally, as program modules include routines, programs, objects, components and data files that perform or assist in the performance of particular functions, it will be understood that the functionality of the software application may be distributed across a number of routines, programs, objects or components to achieve the same functionality as the embodiment and the broader invention claimed herein. Such variations and modifications are within the purview of those skilled in the art.

It will also be appreciated that where methods and systems of the present invention and/or embodiments are implemented by computing systems or partly implemented by computing systems then any appropriate computing system architecture may be utilized. This includes standalone computers, network computers and dedicated computing devices (such as hardware-based arrays).

Where the terms “computer”, “computing system” and “computing device” are used in the specification, these terms are intended to cover any appropriate arrangement of computer hardware for implementing the inventive concept and/or embodiments described herein.

1. A computing device comprising a processing module arranged to interact with a centralized database via a communications network and a database arranged to contain information regarding one or more components within a complex model, wherein the module is arranged to provide the information via the communications network from the device to the centralized database.

2. A computing device in accordance with claim 1, wherein the device generates a unique identifier for each item of information regarding at least one of the one or more components within the complex model.

3. A computing device in accordance with claim 2, wherein the unique identifier is provided with the information to the centralized database.

4. A computing device in accordance with claim 3, wherein the unique identifier is stored as a part of the model.

5. A computing device in accordance with claim 1, wherein the centralized database is updated via the communications network on a periodic basis.

6. A system arranged to interact with one or more remote devices via a communications network comprising a server including a database arranged to contain information regarding one or more components within a complex model, wherein the database is arranged to receive the information via the communications network from the one or more remote devices.

7. A system in accordance with claim 6, wherein the system is further arranged to, on receipt of a request from the one or more remote devices, provide the information regarding one or more components within the complex model to the one or more remote devices.

8. A method for facilitating the transfer of information regarding one or more components within a complex model between one or more remote devices and a centralized database, comprising the steps of, the centralized database receiving a request to provide the information regarding one or more components within the complex model to the one or more remote devices, and forwarding the information via a communications network to the one or more remote devices.

9. A computer program, including at least one instruction capable of being executed by a computing system, which implements a method in accordance with claim 8.

10. A computer readable medium including a computer program in accordance with claim 9.

11. A data signal including at least one instruction being capable of being received and interpreted by a computing system, wherein the one instruction, on being interpreted by the computing system, implements a method in accordance with claim 8.
